(19) United States
(12) Patent Application Publication
(10) Pub. No.: US 2007/0037120 A1
(43) Pub. Date: Feb. 15, 2007

(54) Facial support device

(76) Inventor: Kurt Ritter, Scottsdale, AZ (US)

Correspondence Address: WEISS & MOY PC, 4204 NORTH BROWN AVENUE, SCOTTSDALE, AZ, 85251, US

(21) Appl. No.: 11/192,519

(22) Filed: Jul. 29, 2005

(51) Int. Cl. A61C 5/00

(52) U.S. Cl. 433/140

(57) ABSTRACT

A facial support device configured to provide support to a user's lip, cheek and eyelid thereby helping a user suffering from facial paralysis to speak clearly and to prevent excessive eye-watering or dry-eye syndrome. The facial support device is coupled to a user's ear and to a corner of a user's mouth in order to pull at least a portion of a user's face.

### FIELD OF INVENTION

This invention relates generally to medical devices, and more specifically to a facial support device that provides mouth, cheek and eye support for individuals suffering from facial nerve damage, resultant facial drooping and adversely affected speech.

### BACKGROUND OF THE INVENTION

Bell's Palsy is a disease that results in paralysis of facial nerves and muscle on one side of the face. Because the facial muscles are paralyzed, they allow parts of the face to droop. If the cheek and lips droop they may cause speech difficulty and uncontrollable drooling. Additionally, drooping of the eyelid may cause continuous tearing or dry-eye syndrome. Bell's palsy affects over 40,000 individuals a year. Facial injuries, temporary or permanent, resulting from nerve, muscle, bone or tissue damage can also lead to facial drooping and resultant complications.

Many prior inventions exist that allow a third party, such as a dentist, to retract portions of the lip and cheek for the purposes of inspection. However, these devices are all designed to artificially expose areas of the mouth for the purpose of inspection, not to set facial structures in their proper location. In addition, none of the prior art references are designed to enhance one's speaking ability by supporting a portion of a lip or cheek. Also, no prior art inventions provide a concurrent method for supporting the eyelid.

A need therefore existed for a device that would provide support to the cheek, lip and eyelid of individuals having Bell's Palsy or some other type of facial nerve damage. The device would assist with speech and prevent the eye from drying out.

### SUMMARY OF THE INVENTION

An object of the present invention is to provide a device to enhance the speech of an individual suffering from Bell's Palsy or some other type of facial injury, temporary or permanent, such as a birth defect resulting in facial paralysis.

Another object of the present invention is to provide support to a user's cheek and lip.

Yet another object of the present invention is to provide support to a user's cheek and eyelid.

Still another object of the present invention is to minimize the amount of drool produced by a user.

Still another object of the present invention is to improve a user's eating ability.

### BRIEF DESCRIPTION OF THE PREFERRED EMBODIMENTS

In accordance with one embodiment of the present invention, a facial support device is disclosed. The facial support device comprises, in combination, an earpiece being dimensioned to couple to a user's ear, a shaft having a first end and a second end, the first end being coupled to the earpiece, and a mouthpiece coupled to the second end of the shaft, the mouthpiece being substantially dimensioned to hook inside a user's mouth and pull at least a portion of a user's face.

In accordance with another embodiment of the present invention, a facial support device is disclosed. The facial support device comprises, in combination, a mouthpiece dimensioned to hook inside a user's mouth, and a securing device having a first portion coupled to the mouthpiece and having a second portion dimensioned to couple to a user's ear in order to pull the mouthpiece in a direction of the user's ear.

In accordance with yet another embodiment of the present invention, a method for enhancing speech is disclosed. The method comprises the steps of providing a mouthpiece, providing a securing device coupled to the mouthpiece, hooking the mouthpiece inside a user's mouth, and coupling the securing device to a user's ear so that at least a portion of the user's face being lifted.

In accordance with still another embodiment of the present invention, a method for raising an eyelid is disclosed. The method comprises the steps of providing a mouthpiece, providing a securing device coupled to the mouthpiece, hooking the mouthpiece inside a user's mouth, coupling the securing device to a user's ear, providing an eyelid support device coupled to the securing device, and bracing the eyelid support device against an upper area of a user's cheek so that an eyelid being raised.

In accordance with still another embodiment of the present invention, a method for absorbing saliva is disclosed. The method comprises the steps of providing a mouthpiece, providing a securing device coupled to the mouthpiece, hooking the mouthpiece inside a user's mouth, coupling the securing device to a user's ear, providing a saliva sponge coupled to the mouthpiece, and absorbing saliva of a user by the saliva sponge.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of one embodiment of the facial support device of the present invention, showing the mouthpiece extended and coupled to the shaft with a compression fitting.

FIG. 2 is a perspective view of another embodiment of the facial support device of the present invention, showing the mouthpiece extended and coupled to the shaft with a threaded connection.

FIG. 3 is a perspective view of the facial support device of FIG. 1, showing the mouthpiece retracted into the shaft.

FIG. 4 is a perspective view of the facial support device of FIG. 2, showing the mouthpiece retracted into the shaft.

FIG. 5 is a perspective view of the facial support device of FIG. 1, showing a saliva sponge coupled to the mouthpiece and showing the shaft in phantom.

FIG. 6 is a perspective view of the facial support device of FIG. 2, showing the mouthpiece being screwed into the shaft and showing the shaft in phantom.

FIG. 7 is a perspective view of the facial support device of FIG. 1 in use on a person's face and showing an eyelid support device.

FIG. 8 is a perspective view of another embodiment of the facial support device of the present invention shown in use on a user's face.

FIG. 9A is a side view of the facial support device of FIG. 8.

FIG. 9B is a side, partially phantom view of the facial support device of FIG. 8.

FIG. 9C is a side view of the facial support device of FIG. 8, shown from the opposite side of FIG. 9A.

FIG. 9D is a side, partially phantom view of the facial support device of FIG. 8, shown from the opposite side of FIG. 9B.

### DETAILED DESCRIPTION OF THE PREFERRED EMBODIMENTS

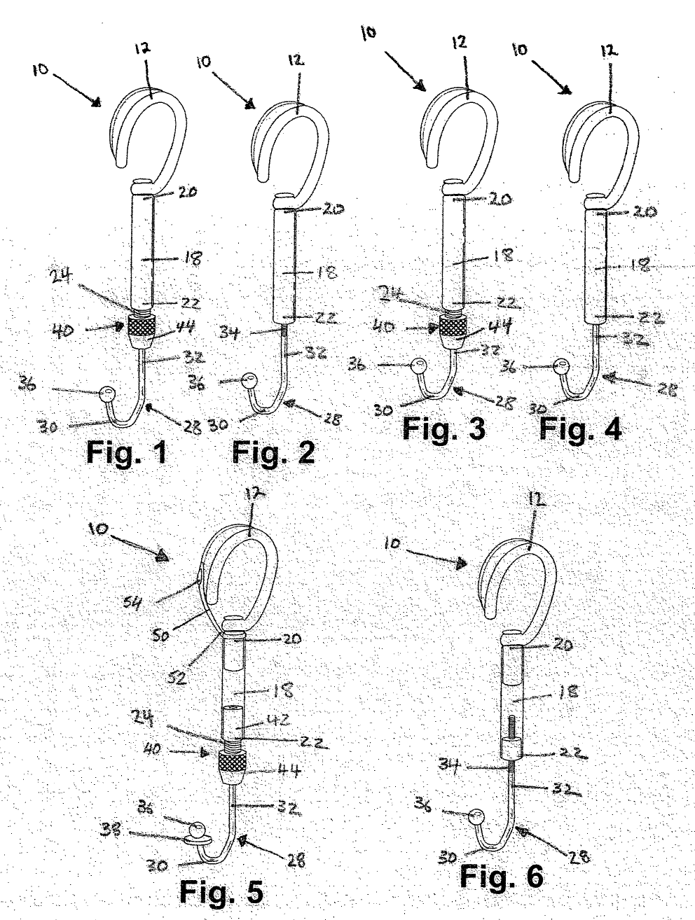

Referring to FIGS. 1-7, reference number 10 refers generally to one embodiment of the facial support device of the present invention.

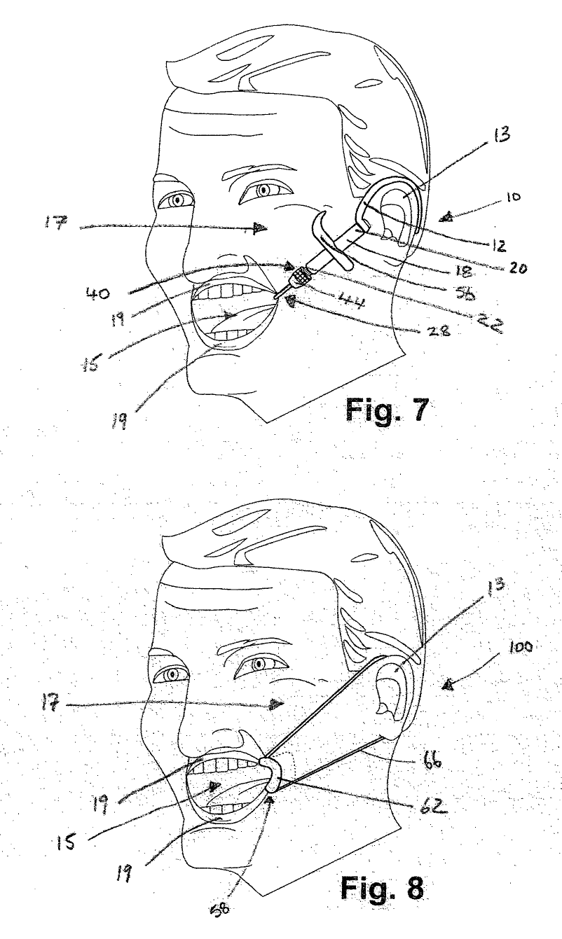

The facial support device 10 comprises an earpiece 12 that is dimensioned to couple to a user's ear 13 (shown in FIG. 7). The facial support device 10 further comprises a shaft 18 having a first end 20 and a second end 22. First end 20 of shaft 18 is coupled to earpiece 12. The facial support device 10 further comprises a mouthpiece 28 coupled to second end 22 of shaft 18. Mouthpiece 28 is substantially dimensioned to hook inside a user's mouth 15 (shown in FIG. 7) and pull at least a portion of user's face 17 (shown in FIG. 7). It should be clearly understood that mouthpiece 28 is dimensioned to hook inside any area of mouth 15, including for example the lips 19 (shown in FIG. 7), so long as mouthpiece 28 is capable of pulling mouth 15, for example upward, in order to keep it from drooping as a result of nerve or muscle damage.

Preferably, mouthpiece 28 is substantially J-shaped with a substantially straight portion 32 (shown in FIGS. 1-6) coupled to second end 22 of shaft 18, although it should be clearly understood that substantial benefit could be derived from an alternative embodiment of the present invention in which mouthpiece 28 is not substantially J-shaped, so long as mouthpiece 28 is capable of pulling at least a portion of a user's face 17.

Mouthpiece 28 may be coupled to second end 22 of shaft 18 in a plurality of manners. FIGS. 1, 3, 5, and 7 show mouthpiece 28 coupled to shaft 18 with a compression fitting 40. Compression fitting 40 comprises a cap 44 and a ferrule 42 (shown in FIG. 5). Ferrule 42 is coupled to both second end 22 of shaft 18 and to mouthpiece 28. Cap 44 is dimensioned to fit around ferrule 42 and couple to a threaded outer surface 24 (shown in FIGS. 1, 3 and 5) of second end 22 of shaft 18. When the compression fitting 40 is loosened, J-shaped mouthpiece 28 can slide in and out of shaft 18 and ferrule 42 thereby allowing the length of facial support device 10 to be adjusted. When the desired length is achieved, cap 44 can be tightened causing ferrule 42 to pinch down on substantially straight portion 32 of J-shaped mouthpiece 28 fixing the facial support device 10 to the desired length.

Alternatively, substantially straight portion 32 of J-shaped mouthpiece 28 may be coupled to second end 22 of shaft 18 by means of a threaded connection. As shown in FIGS. 2, 4, and 6, second end 22 of shaft 18 defines a threaded hole 26. The outer surface 34 proximate end of substantially straight portion 32 of J-shaped mouthpiece 28 is preferably threaded and dimensioned to couple with threaded hole 26. The substantially straight portion 32 of a J-shaped mouthpiece 28 is screwed into threaded hole 26 in the second end 22 of shaft 18. It should be noted that while in one embodiment compression fitting 40 is used to couple and adjust mouthpiece 28 to shaft 18 and in another embodiment shaft 18 defines a threaded hole 26 dimensioned to receive a correspondingly threaded proximate end of mouthpiece 28, substantial benefit could be derived from an alternative embodiment of facial support device 10 in which alternative mechanisms are used to couple and adjust mouthpiece 28 to shaft 18. For example, mouthpiece 28 and shaft 18 may be part of a one-piece assembly without means for adjustment. In addition, other means for coupling or adjusting mouthpiece 28 to shaft 18 are within the spirit and scope of this invention so long as mouthpiece 28 is capable of hooking inside mouth 15 to pull face 17.

Referring now to FIGS. 1-6, the facial support device 10 preferably comprises a substantially spherical-shaped structure 36 coupled to the end of curved portion 30 of J-shaped mouthpiece 28. The spherical-shaped structure 36 is dimensioned to provide a user with a dull end of mouthpiece 28 so as not to injure a mouth area, although it should be clearly understood that substantial benefit could be derived from an alternative embodiment of the present invention in which a spherical-shaped structure 36 is not used, so long as the portion of the mouthpiece 28 inserted into mouth 15 of the user is not sharp.

Referring now to FIG. 5, a saliva sponge 38 is preferably coupled to proximate end of curved portion 30 of J-shaped mouthpiece 28. Saliva sponge 38 is dimensioned to absorb saliva that may collect in mouth 15 of the user. It should be clearly understood, however, that substantial benefit could be derived from an alternative embodiment of the present invention in which there is no saliva sponge 38.

Referring now to FIG. 7, an eyelid support 56 is preferably coupled to shaft 18. Eyelid support 56 is dimensioned to contact with and provide support to an upper cheek area of a user. In this way, eyelid support 56 provides support to a users cheek and eyelid to keep an eye protected that would otherwise be unnecessarily exposed by a drooping face or eyelid. Eyelid support 56 aids in the prevention of continuous tearing and dry-eye syndrome that can occur in many patients suffering from nerve and muscle damage to the face. While, in the preferred embodiment, the facial support device 10 of the present invention comprises an eyelid support 56 it should be clearly understood that substantial benefit could be derived from an alternative embodiment of the present invention in which there is no eyelid support 56, or in which eyelid support 56 is alternatively configured, so long as it is capable of raising at least a portion of the face of a user.

Referring now to FIG. 5, facial support device 10 preferably comprises an earpiece retainer 50. Earpiece retainer 50 has a first end 52 coupled to shaft 18, and a second end 54 detachably coupled to earpiece 12. Earpiece retainer 50 allows facial support device 10 to be more securely coupled to a user's ear 13 by allowing earpiece 12 to be secured around both a front and rear area of ear 13. While, in the preferred embodiment, facial support device 10 comprises an earpiece retainer 50, it should be clearly understood that substantial benefit could be derived from an alternative configuration of facial support device 10 in which there is no earpiece retainer 50 or in which some other mechanism is used to secure earpiece 12 to ear 13.

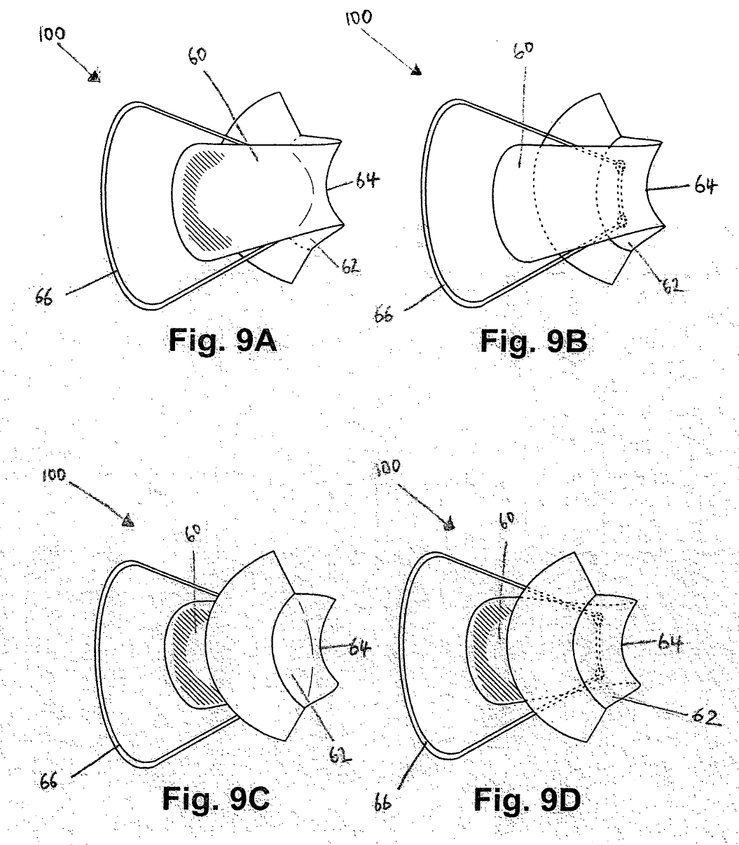

Referring now to FIGS. 8, 9A, 9B, 9C and 9D, an alternative embodiment of the facial support device 10, hereinafter facial support device 100, is shown. Facial support device 100 comprises a mouthpiece 58 and a securing device 66. Mouthpiece 58 is designed to couple with a corner of a user's mouth. Mouthpiece 58 is preferably a curvilinear structure roughly forming a saddle shape and having an internal portion 60 (shown in FIGS. 9A-9D) and an external portion 62 that are joined at an elbow 64 (shown in FIGS. 9A-9D). Preferably, the internal portion 60 of mouthpiece 58 is longer than the external portion 62. The securing device 66 is coupled to mouthpiece 58 proximate elbow 64 and is dimensioned to couple to user's ear 13. While, in the preferred embodiment of facial support device 100 mouthpiece 58 is curvilinear in shape, forming a saddle shape and has an internal portion 60 that is longer than the external portion 62, it should be clearly understood that substantial benefit could be derived from an alternative embodiment of the facial support device 100 in which the mouthpiece 58 is alternatively shaped or the internal portion 60 is not longer than the external portion 62 so long as the mouthpiece 58 is capable of securely coupling to the user's mouth area 15.

While the invention has been particularly shown and described with reference to the preferred embodiments thereof, it will be understood by those skilled in the art that the foregoing and other changes in form and details may be made therein without departing from the spirit and scope of the invention. For example, the facial support device 10 could be constructed from any materials that are suitable for its application. The preferably J-shaped mouthpiece 28 may be formed into different shapes. An individual may require a mouthpiece having a different shape to match his or her facial geometry. The length of the device may be fixed; it does not necessarily have to be adjustable. It may be formed from a single piece of material and may be either solid or hollow. The J-shaped mouthpiece 28 can be coupled to the shaft in many different ways. Any method that allows the J-shaped mouthpiece 28 to be securely fixed to the shaft would satisfy the requirements of this invention. With respect to facial support device 100, the securing device 66 may be an elastic band or any other suitable structure that will securely couple to a user's ear and allow the mouthpiece to pull on a user's lip and cheek. Also, the mouthpiece 58 may be formed into different shapes in order to more comfortably couple with the corner of a mouth of a user.

I claim:

1. A facial support device comprising:
an earpiece being dimensioned to couple to a user's ear;
a shaft having a first end and a second end, said first end being coupled to said earpiece; and .
a mouthpiece coupled to said second end of said shaft, said mouthpiece being substantially dimensioned to hook inside a user's mouth and pull at least a portion of a user's face.

2. The device of claim 1 wherein said mouth piece being substantially J-shaped and having a curved portion and a substantially straight portion, said substantially straight portion being coupled to said second end of said shaft and said curved portion being substantially dimensioned to hook inside a user's mouth.

3. The device of claim 1 further comprising a substantially spherical-shaped structure coupled to said mouthpiece.

4. The device of claim 1 further comprising a saliva sponge coupled to said mouthpiece and dimensioned to absorb saliva.

5. The device of claim 1 further comprising an eyelid support device coupled to said shaft and dimensioned to contact with and provide support to an upper cheek area of a user.

6. The device of claim 1 wherein said earpiece being substantially C-shaped and anatomically molded to fit around a user's ear, said earpiece having a first end and a second end, said first end being coupled to said first end of said shaft.

7. The device of claim 6 further comprising an earpiece retainer having a first end and a second end, said first end of said earpiece retainer coupled proximate said first end of said earpiece and said second end of said earpiece retainer detachably coupled proximate said second end of said earpiece, said earpiece retainer being dimensioned to allow a user to secure said earpiece around a user's ear with said earpiece retainer.

8. The device of claim 1 wherein said mouthpiece being adjustably coupled to said second end of said shaft so that said mouthpiece may be at least one of extended and retracted relative to said second end of said shaft so that an overall length of said facial support device being adjustable.

9. A facial support device comprising:
a mouthpiece dimensioned to hook inside a user's mouth; and
a securing device having a first portion coupled to said mouthpiece and having a second portion dimensioned to couple to a user's ear in order to pull said mouthpiece in a direction of said user's ear.

10. The device of claim 9 wherein said securing device comprises an elastic band dimensioned to wrap around a user's ear.

11. The device of claim 9 wherein said mouthpiece being substantially saddle-shaped.

12. A method for enhancing speech comprising the steps of:
providing a mouthpiece;
providing a securing device coupled to said mouthpiece;
hooking said mouthpiece inside a user's mouth; and
coupling said securing device to a user's ear so that at least a portion of said user's face being lifted.

13. The method described in claim 13 further comprising the step of adjusting said facial support device to fit said user.

14. A method for raising an eyelid comprising the steps of:
providing a mouthpiece;
providing a securing device coupled to said mouthpiece;
hooking said mouthpiece inside a user's mouth;
coupling said securing device to a user's ear;
providing an eyelid support device coupled to said securing device; and
bracing said eyelid support device against an upper area of a user's cheek so that an eyelid being raised.

15. A method for absorbing saliva comprising the steps of:
providing a mouthpiece;
providing a securing device coupled to said mouthpiece;
hooking said mouthpiece inside a user's mouth;
coupling said securing device to a user's ear;
providing a saliva sponge coupled to said mouthpiece; and
absorbing saliva of a user by said saliva sponge.
